(19) United States
(12) Patent Application Publication
(10) Pub. No.: US 2003/0037017 A1
(43) Pub. Date: Feb. 20, 2003

(54) Quick personality evaluation for function suitability

(75) Inventor: Avigdor Rimmer, Herzliya Pituach (IL)

Correspondence Address: DR. MARK FRIEDMAN LTD., C/O BILL POLKINGHORN- DISCOVERY DISPATCH, 9003 FLORIN WAY, UPPER MARLBORO, MD, 20772, US

(73) Assignee: PILAT TECHNOLOGIES LTD.

(21) Appl. No.: 09/931,892

(22) Filed: Aug. 20, 2001

(51) Int. Cl. G06N 5/02; G06F 17/00

(52) U.S. Cl. 706/47

(57) ABSTRACT

A method for evaluating the personality of a person by asking that the person graphically represent his or her life in a map. In the map, points represent significant events or people, lines connecting the points represent a relationship between the events or people represented by the points, and encircling lines are used to delineate points with a common trait. The map is evaluated according to the “big five” personality factors. The evaluation is useful for helping select a person from amongst a number of candidates or for initiating a conversation about the person who drew the map.

### FIELD AND BACKGROUND OF THE INVENTION

The present invention relates to the evaluation of persons and more particularly, to a method to evaluate the personality of a person who is a candidate for a function.

It is well known in the art that in addition to skills and experience, success in a function depends on the personality of a person performing the function. This is exceptionally important in higher-level functions such as performed by persons in management or leadership positions. As a result, organizations evaluate aspects of the personality of candidates for higher-level functions as part of the process of selecting a person to perform such a function.

In principle, the evaluation methods known in that art can be divided into two groups: those based on a clinical approach and those based on a statistical approach.

Methods based on a clinical approach most often include an interview of the candidate by an examiner. The examiner makes an evaluation based on such factors as the answers the candidate gives, the body language of the candidate, and a general impression of the candidate throughout the interview. Often, the candidate is asked to perform seemingly trivial tasks that reveal relevant aspects of the personality of the candidate. For example, the candidate may be asked to relate a story based on a series of drawings or to draw a tree. Depending on what story is told or how the tree is drawn, the examiner decides what personality traits the candidate has and evaluates the relative suitability of the candidate for a given function.

The problem with methods based on the clinical approach is that the examiner must be a highly-skilled professional. This means that the test is necessarily expensive. Furthermore, there is no agreed upon way to validate such a method. Since the conclusions of such an interview are dependent on examiner skill, such an examination is never truly objective. Additionally, methods based on the clinical approach are influenced by cultural differences. Such methods are therefore not suitable for international organizations that perform selection processes for functions amongst various candidates from different cultures at geographically disparate locations.

Statistical methods, most often in the form of psychometric tests, are based on the candidate filling out a number of multiple-choice questionnaires with a large number of questions. Based on the answers given to the questions posed, a personality profile of the candidate is made. The personality profiles of all candidates for a function are compared to an ideal personality profile for that function. The candidate whose answers mostly closely match the ideal personality profile is selected for the function. The greatest advantages of methods based on the statistical approach is that the tests are quick, cheap and objective. Such a test can be performed by a plurality of candidates simultaneously under the supervision of a person with no particular skills or even at remote locations. The results are checked automatically.

There are a number of disadvantages to methods based on the statistical approach. Suitability for a given function is based on fixed criteria so exceptionally talented candidates may be rejected if they do not fit a predetermined mold. Often, answers may be learned allowing a so-inclined candidate to fake suitability for a function. There even exist commercial organizations that teach candidates to undergo such tests.

It would be highly advantageous to have a method to evaluate the personality of a candidate in the context of evaluating suitability for a function that does not have the disadvantages of the evaluation methods known in the art.

In the description and claims found hereinbelow, it is understood that when a person is referred to, in all cases a person of any gender is meant, whether explicitly mentioned or not. Thus, in all cases “his” is understood to mean “his” or “her”, and “himself” is understood to mean “himself” or “herself”.

### SUMMARY OF THE INVENTION

The above and other objectives are achieved by the innovative method provided by the present invention.

The method of the present invention can be seen as incorporating elements found in methods based on both the clinical and the statistical approach. On the one hand, the method of the present invention resembles an open-ended projective test with a narrative report, similar to a test performed based on the clinical approach. At the same time, the method of the present invention produces a score for each candidate, the score being related to the so-called “big five” personality factors, known to one skilled in the art. Unique to the method of the present invention, the candidate is asked to perform a job relevant and non-psychological task, where he is considered to be the expert. Furthermore, the results of the initial assessment are fed back to the candidate as part of the evaluation process. As such, the method of the present invention is based on a new third approach named the dialogue approach.

There is provided according to the teachings of the present invention a method for evaluating the personality of a person by first instructing the person to graphically represent his or her life using a map made of:

i. points, each one of the points representing an entity, that is a person, object, concept or event, significant in the life of the person, each one of the points accompanied by an annotation explaining the meaning of the point;

ii. connecting lines, each one of the connecting lines connecting at least two of the points, wherein each one of the connecting lines represents a relationship between the entities represented by respective points, each connecting lines accompanied by a respective annotation explaining the meaning of the relationship; and

iii. encircling lines, each one of the encircling lines encircling a group of points, so that entities represented by the encircled points share some common trait, each encircling line accompanied by a respective annotation explaining what the nature of the common trait is.

Thereafter, an assessor evaluates the map and draws conclusions concerning the personality of the person who drew the map. The evaluation of the map includes:

a) judging conformity and adherence to rules by the person as represented in the map;

b) judging achievement orientation of the person as represented in the map;

c) judging sociability of the person as represented in the map;

d) judging intellectual orientation of the person as represented in the map; and

e) judging emotional stability of the person as represented in the map.

According to the teachings of the present invention, the map can be used for ascertaining the relative suitability for a function of a plurality of candidates, by evaluating a map drawn by each candidate and comparing the evaluations.

Still further, according to the teachings of the present invention, the map can be used to initiate a conversation about the person. In such an embodiment the map is used as a starting point and a common frame of reference to help an assessor discuss the candidate. Such a use of the present invention is exceptionally useful as an aid in a manager development regimen.

### BRIEF DESCRIPTION OF THE DRAWINGS

The invention is herein described, by way of example only, with reference to the accompanying drawings, wherein:

FIGS. 1A-1H illustrate eight maps drawn according to the method of the present invention by eight candidates for a function, wherein each one of the candidates received identical instructions.

### DESCRIPTION OF THE PREFERRED EMBODIMENTS

The present invention is a method, which allows the evaluation of the personality of a person, for example in the context of evaluating suitability for a function that does not have the disadvantages of the evaluation methods known in the art. In all embodiments of the present invention, the candidate first draws a map (known commercially as a Carta-Vita which is then evaluated by an assessor. Further use of the map depends on the specific embodiment and the reason for the map being drawn

As a first step of the present invention, the candidate is equipped with drawing equipment, for example, a pencil and paper (for instance of A3 or 17″×22″ format). Thereafter the candidate is asked to draw a map of his or her life as the candidate sees it, following four guidelines:

1) points are used to represent entities (events or people) significant in the life of the candidate. Accompanying each point, the significance of that point is annotated;

2) connecting lines joining two points are used to represent a connection or a relationship between two entities represented by the two points. Accompanying each connecting line, the significance of that connecting line is annotated;

3) encircling lines are used to encircle groups of points which represent entities which are related by some common trait, for example the events the group of points represent occurred concurrently. Accompanying each encircling line, the significance of that encircling line is annotated; and

4) further comments, helpful in understanding the map are annotated on the map.

The candidate is given a limited amount of time to draw the map, for example 30 minutes.

Once the candidate has finished drawing the map, an assessor evaluates the map based on the “big five” personality factors:

1) conformity and adherence to the rules: the degree to which the candidate follows the instructions, as well as the degree to which the candidate divides his or her life into conventional categories;

2) achievement orientation: the degree to which the candidate uses the space available, the degree of linearity in the map, and the degree in which dynamic relations between entities is found;

3) sociability: the number of points representing people relative to the number of points representing events, concepts, ideologies or the candidate self;

4) intellectual orientation: the degree that the map contains rich or conceptual material, as opposed to dull and concrete material; and

5) emotional stability: the degree to which the map seems balanced and without strange content or over-emphasis of irrelevant events.

The assessor is also asked to give an intuitive impression of the candidate based on the map. In some embodiments of the present invention the assessor may also score the candidate in each one of the personality factors. Scoring is well known to one skilled in the art and may, for example, be on a scale of 1 through 5, 1 through 6, or 1 through 10.

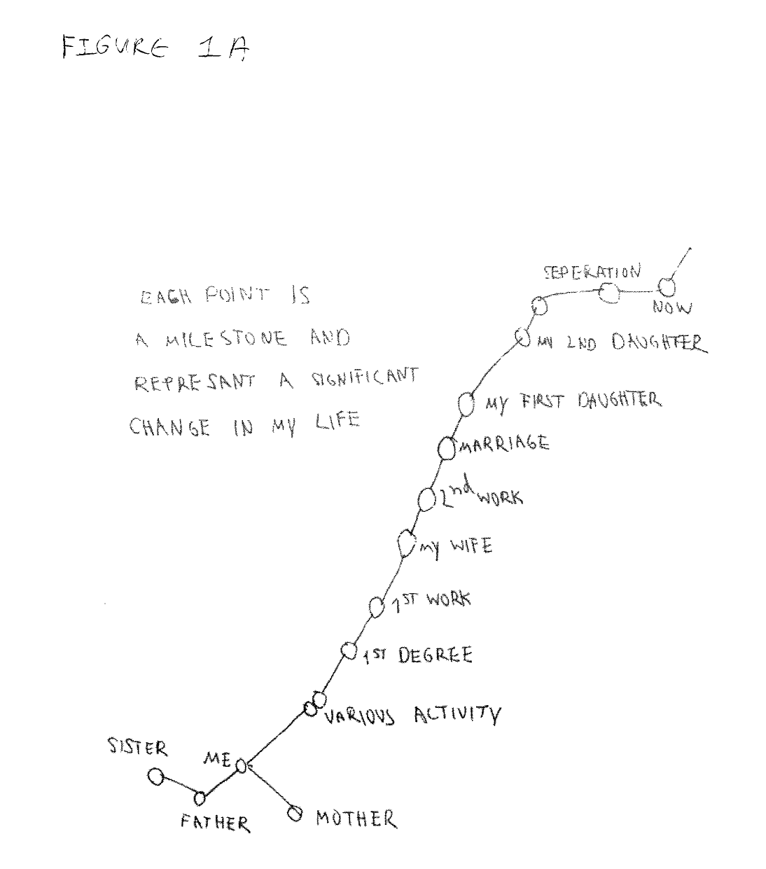

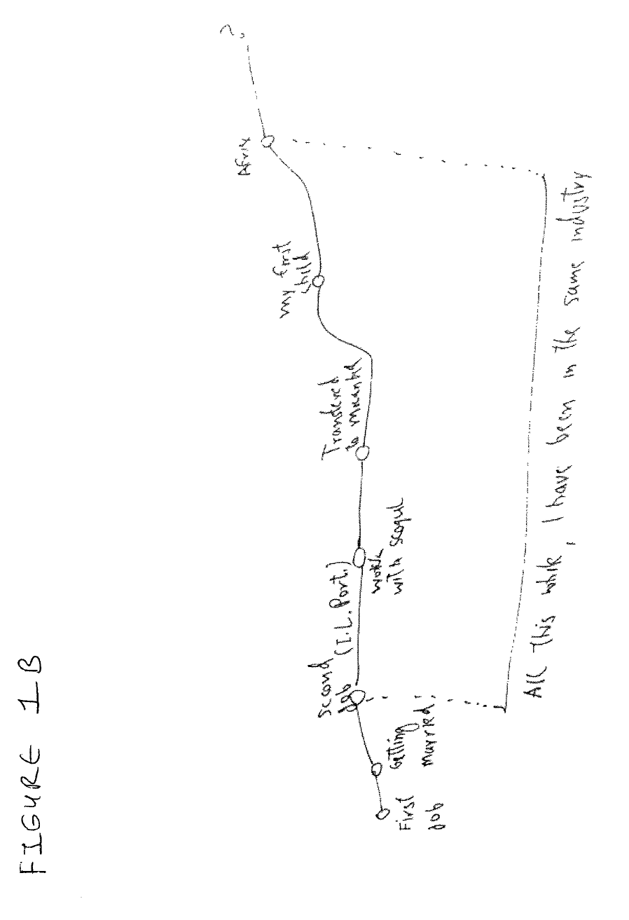

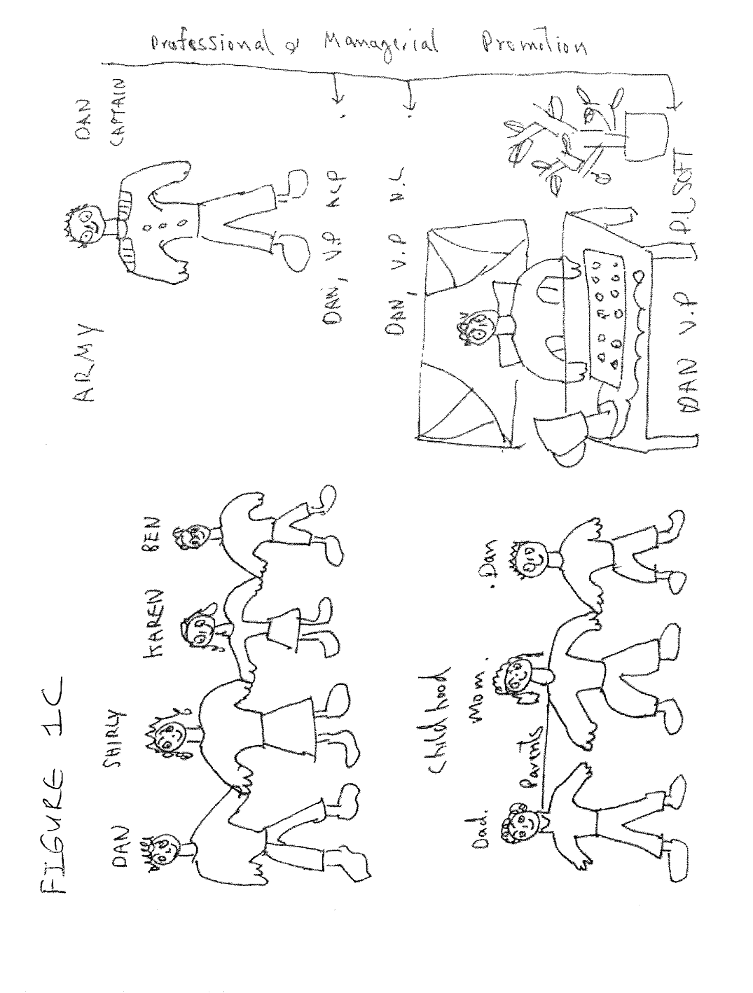

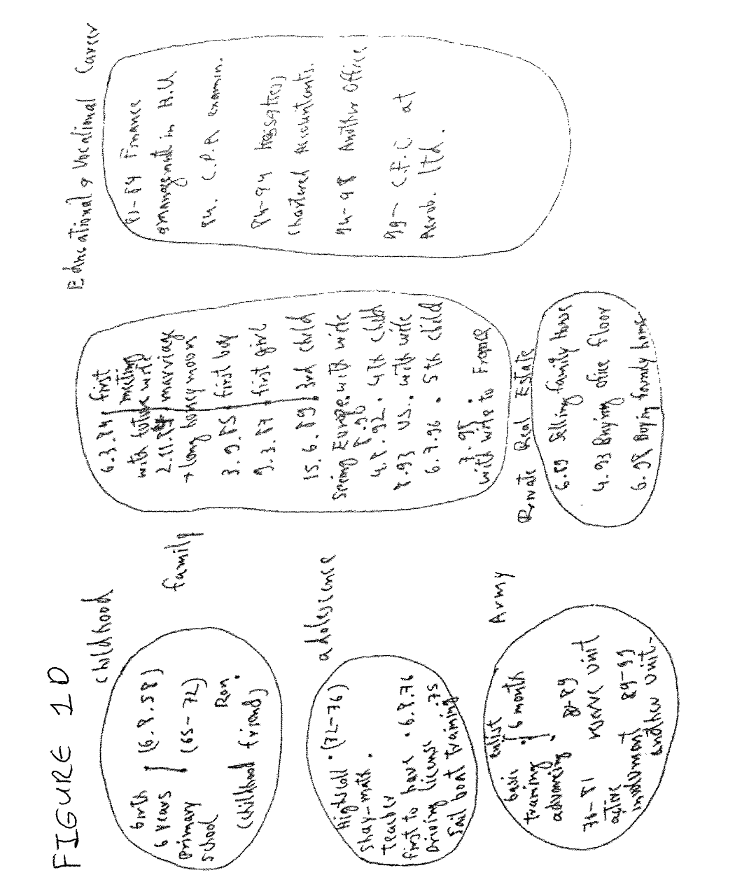

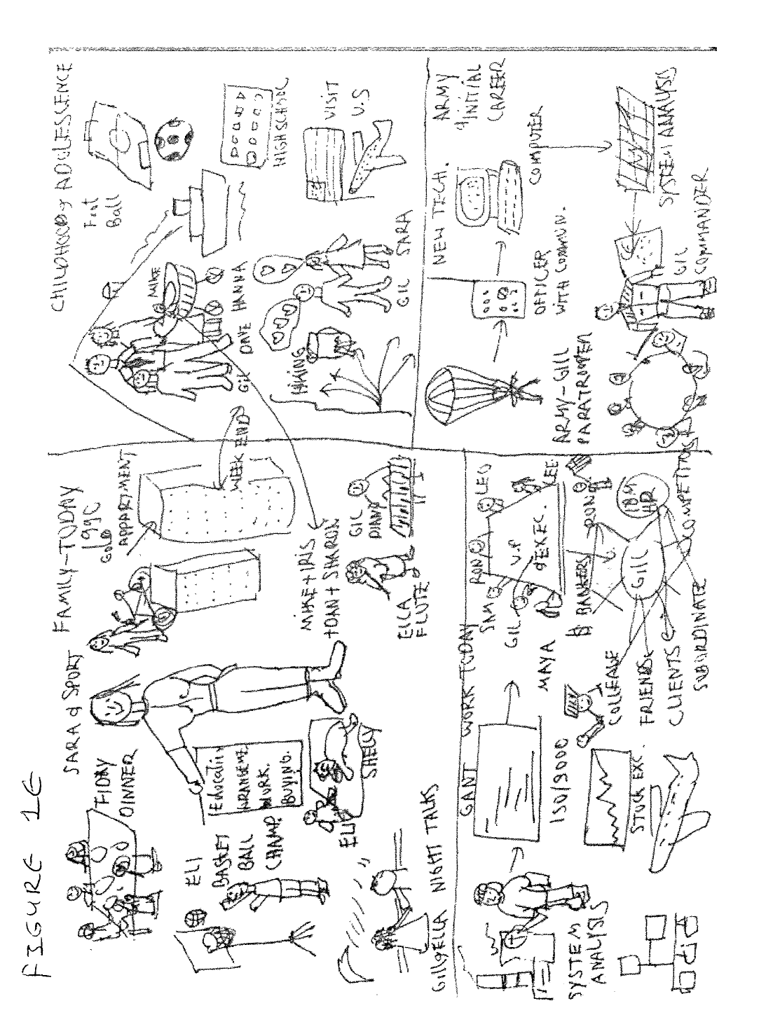

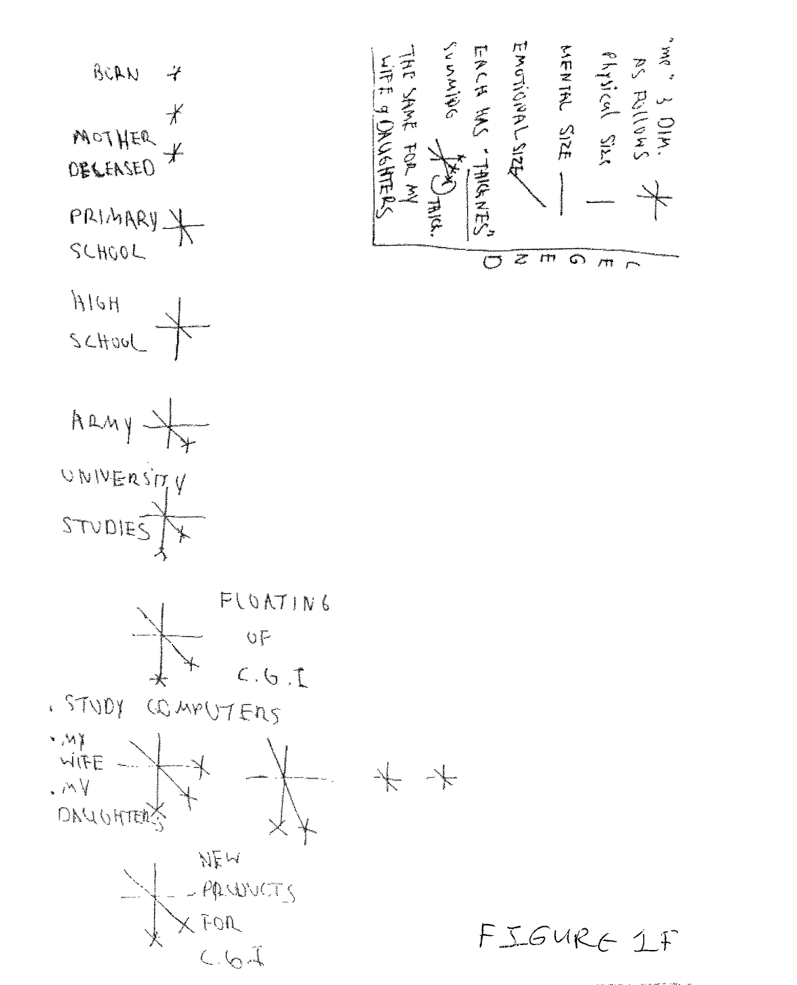

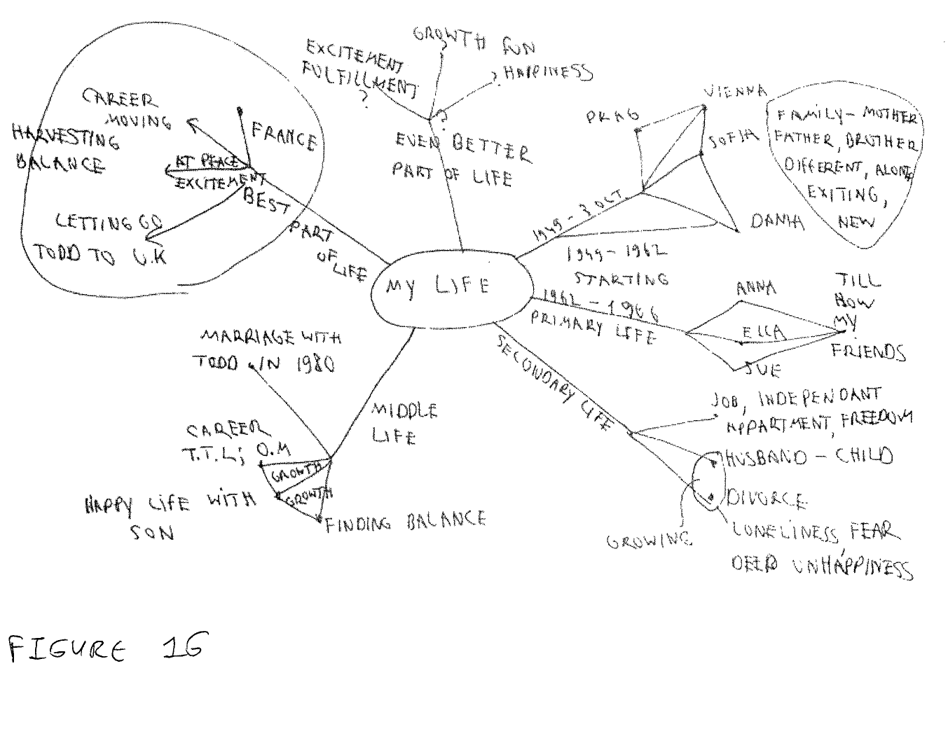

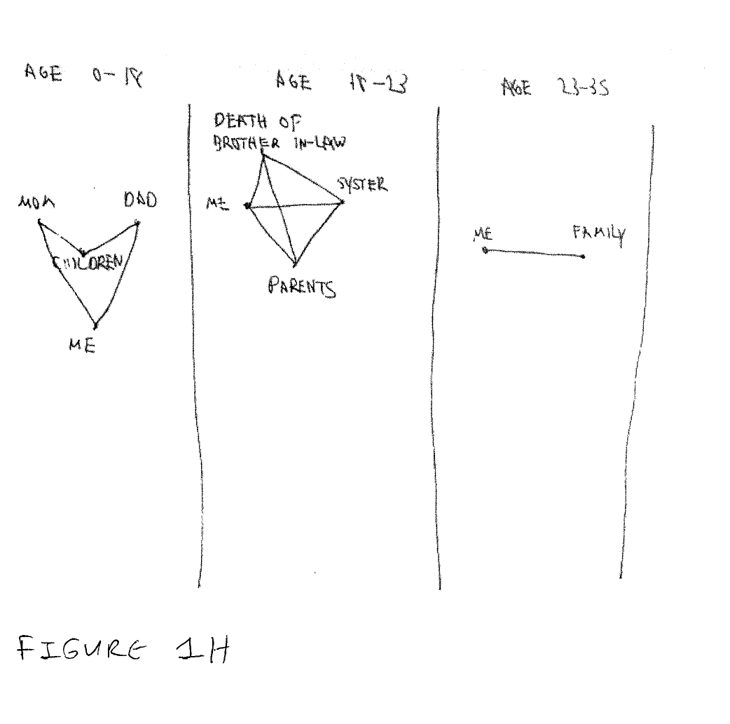

FIGS. 1A through 1H show eight different maps drawn by eight different candidates, each candidate having received identical instructions, substantially the same instructions as described hereinabove. As is clear to one skilled in the art, the great variation in map structure and content reflects variations in personality of the eight candidates. It is clear to one skilled in the art that the map as drawn and evaluated above can be useful in various situations concerning evaluation of a person.

When the maps illustrated in FIGS. 1A through 1H were evaluated by five highly-skilled professionals in accordance with the hereinabove listed instructions, substantially identical evaluations were made

For example, when the map illustrated in FIG. 1D was evaluated by five highly-skilled professionals the following personality traits were agreed upon:

1) The candidate has a high level of conformity and adherence to the rules. He follows the rules precisely, puts his life in the proper drawers and does not add something of his own;

2) The candidate is highly achievement oriented. Although it lacks dynamic structure, the contents of his map are full of references to career, property and other achievements. Even his family life and his childhood are painted with “achievement colors”;

3) The candidate has a relatively low sociability. The map shows a relative low proportion of social life or emotional bonds. There is something rather mechanical in the way he relates to people;

4) The candidate has a low intellectual orientation. Although he provides many details, he is very concrete, even dull in the way he describes his life: the map is too schematic and does not depict curiosity or conceptual orientation; and

5) The candidate has an average level of emotional stability. He values stability to the point of being unemotional. He lacks flexibility, but retains a well-organized and well-planned life.

In a second example, when the map illustrated in FIG. 1E was evaluated by five highly-skilled professionals the following personality traits were agreed upon:

1) The candidate has a middling level of conformity and adherence to the rules. She has her own subjective way to interpret the rules. So while trying to include everything, she sails away from strict graph theory into a pictorial world;

2) The candidate is highly achievement oriented. She is highly ambitious, competitive, dynamic, full of herself, energetic and vibrant. Her childhood is painted in “achievement colors”;

3) The candidate has a relatively high sociability. The map shows lots of people, interpersonal relationships, social activity. She is always amongst others and has a need for attention, affection and contact;

4) The candidate has a middling intellectual orientation. She is curious, has artistic and creative tendencies, yet she is not very conceptual in her conduct; and

5) The candidate has a low level of emotional stability. The disproportion of elements and the extensive exposure all are indicative of an immature and unstable personality, yet she is not lacking in humor or personal charm.

Although the assessor of a map drawn in accordance to the method of the present invention may be a highly-skilled professional, evaluation of the map may be performed by a different person, such as an assistant or trainee who has been briefed by a highly-skilled professional. Evaluation of a map, as described above, takes about 5 minutes.

In one embodiment of the present invention, the map is used to make a pre-selection of a limited number of candidates from amongst a plurality of candidates, as is often done using statistical tests. A plurality of candidates is instructed to draw maps. All the maps are evaluated and only the most suitable candidates are selected for further consideration. This embodiment of the present invention has numerous advantages over pre-selection methods known in the art. The quality of information gathered concerning the personality of the candidates is significantly higher than can be gleaned from statistical tests or through perusal of the curriculum vitae of the candidates. Thus, the pre-selection made according to the method of the present invention is significantly more effective than methods based on the statistical approach. On the other hand, the evaluation of the map is objective, culture-neutral, does not necessitate the use of highly-skilled professionals as assessors and is quicker then methods based on the clinical approach.

Pre-evaluation using the method of the present invention is exceptionally useful when the personality of a large number of candidates located in disparate geographical locations need to be evaluated. Since the role of the assessor is limited when compared to the role in methods based on the clinical approach, pre-selection performed according to the method of the present invention is more objective then a pre-selection performed using existing clinical evaluation methods. This allows for evaluation of maps locally with only the results being sent to a central location. At the central location, a decision as to which candidates are to undergo a full assessment (e.g., personal interview performed by a highly-skilled professional) is made.

A further use of the method of the present invention as described hereinabove is in establishing a dialogue between a candidate and an assessor during a formal interview. As is known to one skilled in the art, an assessor prepares for an interview of a candidate by reviewing the curriculum vitae of the candidate and results of the statistical and clinical evaluations performed. Curriculum vitae list candidate achievements and thus reflect little more than professional qualifications. The results of the statistical and clinical evaluations are hidden from the candidate and as such have an intimidating effect on the candidate. Furthermore, the fact that the results are known only to the assessor leads to an antagonistic and confrontational relationship between the assessor and the candidate, influencing the interview and its results. When the map of the present invention is used by an assessor as the basis for the interview, the fact that the map is open and has been drawn by the candidate self leads to a non-antagonistic conversation between equals which allows the candidate to present his or her qualifications without intimidation. As such, when used within the framework of selection of a person for a function, the method of the present invention is useful in establishing a dialogue.

In a still further embodiment of the present invention, the method of the present invention is used as part of a manager development program. Often an organization, such as a commercial enterprise, is interested in helping individuals in management functions develop on a personal level. Management development programs often include discussions with highly-skilled professionals to help discern the weak points and problems of an individual manager. By preceding such a discussion with the drawing of a map as described above, a non-confrontational dialogue is quickly developed between the manager and the highly-skilled professional. Since the manager is the one who has drawn the map, an in-depth dialogue which concentrates on the manager self is established.

While the invention has been described with respect to a limited number of embodiments, it will be appreciated that many variations, modifications and other applications may be made without exceeding the spirit and scope of the present invention.

What is claimed is:

1. A method for the evaluation of the personality of a person comprising:
a) instructing the person to graphically represent the life of the person using a map, said map including:
i. points, each one of said points representing an entity significant in said life of the person, each one of said points accompanied by a respective first annotation, said first annotation textually explaining the meaning of respective said entity;
ii. connecting lines, each one of said connecting lines connecting at least two of said points, wherein each one of said connecting lines represents a relationship between said entities represented, each respectively, by one of said points, each one of said connecting lines accompanied by a respective second annotation, said second annotation textually explaining the meaning of said relationship;
iii. encircling lines, each one of said encircling lines encircling one or more of said points, so that entities represented by respective encircled points share a common trait, each one of said encircling lines accompanied by a respective third annotation, said third annotation textually explaining the meaning of said common trait; and
b) drawing conclusions concerning the personality of the person by evaluating said map.

2. The method of claim 1 wherein said evaluating includes:
a) judging conformity and adherence to rules by the person as represented in said map;
b) judging achievement orientation of the person as represented in said map;
c) judging sociability of the person as represented in said map;
d) judging intellectual orientation of the person as represented in said map; and
e) judging emotional stability of the person as represented in said map.

3. A method for ascertaining the relative suitability for a function of a plurality of candidates, comprising:
a) instructing each of the plurality of candidates to individually graphically represent the respective life of the respective candidate using a map, said map including:
i. points, each one of said points representing an entity significant in said life of the person, each one of said points accompanied by a respective first annotation, said first annotation textually explaining the meaning of respective said entity;
ii. connecting lines, each one of said connecting lines connecting at least two of said points, wherein each one of said connecting lines represents a relationship between said entities represented, each respectively, by one of said points, each one of said connecting lines accompanied by a respective second annotation, said second annotation textually explaining the meaning of said relationship; and
iii. encircling lines, each one of said encircling lines encircling one or more of said points, so that entities represented by respective encircled points share a common trait, each one of said encircling lines accompanied by a respective third annotation, said third annotation textually explaining the meaning of said common trait; and
b) drawing conclusions concerning the suitability for the function of each one of the plurality of candidates by evaluating each one of respective said maps; and
c) selecting from amongst the plurality of candidates one or more most suitable candidates.

4. The method of claim 3 wherein said evaluating includes:
a) judging conformity and adherence to rules by each one of the candidates as represented in said map;
b) judging achievement orientation of each one of the candidates as represented in said map;
c) judging sociability of each one of the candidates as represented in said map;
d) judging intellectual orientation of each one of the candidates as represented in said map; and
e) judging emotional stability of each one of the candidates as represented in said map.

5. A method for initiating a conversation about a person comprising:
a) instructing the person to graphically represent the life of the person using a map, said map including:
i. points, each one of said points representing an entity significant in said life of the person, each one of said points accompanied by a respective first annotation, said first annotation textually explaining the meaning of respective said entity;
ii. connecting lines, each one of said connecting lines connecting at least two of said points, wherein each one of said connecting lines represents a relationship between said entities represented each respectively by one of said points, each one of said connecting lines accompanied by a respective second annotation, said second annotation textually explaining the meaning of said relationship; and
iii. encircling lines, each one of said encircling lines encircling one or more of said points, so that entities represented by respective encircled points share a common trait, each one of said encircling lines accompanied by a respective third annotation, said third annotation textually explaining the meaning of said common trait;
b) drawing conclusions concerning the personality of the person by evaluating said map; and
c) discussing said conclusions with the person.

6. The method of claim 5 wherein said evaluating includes:
a) judging conformity and adherence to rules by the person as represented in said map;
b) judging achievement orientation of the person as represented in said map;
c) judging sociability of the person as represented in said map;
d) judging intellectual orientation of the person as represented in said map; and
e) judging emotional stability of the person as represented in said map.
